(19) United States
(12) Patent Application Publication
(10) Pub. No.: US 2014/0377698 A1
(43) Pub. Date: Dec. 25, 2014

(54) POLYMERIZED TONER AND A METHOD FOR PREPARING THE SAME

(71) Applicant: LG CHEM, LTD., Seoul (KR)

(72) Inventors: Wook Jang, Daejeon (KR); Chang-Soon Lee, Daejeon (KR); Woo-Cheul Jung, Ulsan (KR); Jung Woo Kim, Daejeon (KR)

(73) Assignee: LG CHEM, LTD., Seoul (KR)

(21) Appl. No.: 14/369,446

(22) PCT Filed: Dec. 4, 2012
(86) PCT No.: PCT/KR2012/010427

§ 371 Date: Jun. 27, 2014

(30) Foreign Application Priority Data
Dec. 27, 2011 (KR) 10-2011-0143743
Dec. 3, 2012 (KR) 10-2012-0139075

(51) Int. Cl. G03G 9/08

(52) U.S. Cl. CPC G03G 9/0806
USPC 430/108.22; 430/108.4; 430/108.3; 430/137.15

(57) ABSTRACT

This disclosure relates to a polymerized toner prepared by suspension polymerization. Particularly, this disclosure relates to a polymerized toner that further comprises a specific functional macro monomer, a polymer thereof, or a mixture thereof, in addition to a binder resin, and a pigment, a pigment stabilizer, a charge control agent and wax, which are dispersed in the binder resin, and thus can be fixed at low temperature in a development process, and exhibit high glossiness and excellent transfer efficiency.

### TECHNICAL FIELD

The present invention relates to a polymerized toner and a method for preparing the same. More particularly, the present invention relates to a polymerized toner that can be fixed at low temperature, and thus, is energy-efficient, may exhibit high glossiness, and may exhibit very excellent performance in the application field such as development of electronic photographs, and the like.

### BACKGROUND ART

A toner refers to a paint that is used for the development of electronic photographs, an electrostatic printer, a copier, and the like, and can be transferred and fixed to an article to form desired patterns. Recently, as documentation using a computer is generalized, demands for an image forming apparatus such as a printer are rapidly increasing, and thereby, the amount of toner consumed is also increasing.

In general, a method for preparing a toner includes a preparation method by pulverization and a preparation method by polymerization. In the preparation method by pulverization, which is most widely known, resin and pigment are introduced together through a melt-mixing process, they are melt-mixed or extruded, and then, pulverized and classified to prepare toner particles. However, since toner particles prepared by this process have very irregular shapes such as wide particle diameter distribution, sharp edges, and the like, they have problems in that chargability or flowability is not good.

In order to solve these problems, a method for preparing spherical toner particles by a polymerization method has been suggested. As the preparation method of toner by polymerization, an emulsion polymerization method (aggregation method) and a suspension polymerization method are known, but the emulsion polymerization method is difficult to control particle size distribution, and has a problem in terms of quality reproducibility of prepared toner, and thus, a preparation method of toner by suspension method is more favored.

In the suspension polymerization method, monomers for a binder resin, and various additives such as a pigment, a pigment stabilizer, wax, a charge control agent, an initiator, and the like are uniformly dispersed to prepare a monomer mixture, and the mixture is dispersed in an aqueous dispersion in the form of fine droplets, and then, a polymerization reaction is conducted to prepare a polymerized toner in the form of particle appropriate for toner.

However, toner particles prepared by the suspension polymerization are not sufficiently molten and fixed at low fixing temperature in the development process, so-called cold off set problem is generated, and thus, there are a lot of energy consumptions because toner should be fixed at high temperature.

Accordingly, there is a need for the development of a polymerized toner that can be fixed at low temperature in the development process and realize high glossiness and excellent transfer efficiency together.

### DISCLOSURE

### Technical Problem

It is an object of the present invention to provide a polymerized toner that can be fixed at low temperature, is energy-efficient, may exhibit high glossiness and excellent transfer efficiency, and thus, may exhibit very excellent printing performance in the application field such as development of electronic photograph, and the like, and a method for preparing the same.

### Technical Solution

The present invention provides a polymerized toner comprising a binder resin; and a pigment, a pigment stabilizer, a charge control agent, wax, and a functional macro monomer represented by the following Chemical Formula 1, a polymer thereof, or a mixture thereof, which are dispersed in the binder resin, wherein the functional macro monomer has weight average molecular weight of 500 to 5,000, and is included in the amount of 0.05 to 5 parts by weight, based on total weight of the toner.

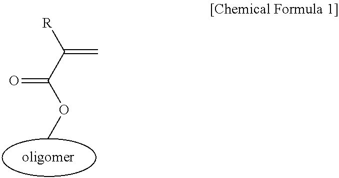

wherein,

R is hydrogen or methyl,

oligomer is independently ester oligomer, urethane oligomer, olefin oligomer, ethyleneglycol oligomer, methylsiloxane oligomer, dimethyldichlorosilane oligomer, dimethylpolysiloxane oligomer, hexamethyldisilazane oligomer, aminosilane oligomer, alkylsilane oligomer, or octamethylcyclotetrasiloxane oligomer.

The present invention also provides a method for preparing a polymerized toner comprising forming an aqueous dispersion comprising a dispersant; forming a monomer mixture comprising monomers for a binder resin, a pigment, a pigment stabilizer, a charge control agent, wax, and a functional macro monomer represented by the following Chemical Formula 1, a polymer thereof or a mixture thereof; and adding the monomer mixture to the aqueous dispersion to form toner particles through suspension polymerization, wherein the functional macro monomer has weight average molecular weight of 500 to 5,000, and is included in the amount of 0.05 to 5 parts by weight, based on total weight of the toner.

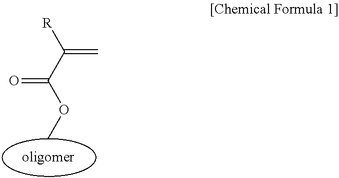

wherein,

R is hydrogen or methyl,

oligomer is independently ester oligomer, urethane oligomer, olefin oligomer, ethyleneglycol oligomer, methylsiloxane oligomer, dimethyldichlorosilane oligomer, dimethylpolysiloxane oligomer, hexamethyldisilazane oligomer, aminosilane oligomer, alkylsilane oligomer, or octamethylcyclotetrasiloxane oligomer.

Hereinafter, a polymerized toner and a method for preparing the same according to specific embodiments of the invention will be explained in detail. However, these are presented as one example of the invention, the right scope of the invention is not limited thereto, and it is obvious to one of ordinary knowledge in the art that various modifications may be made thereto within the right scope of the invention.

As used herein, unless otherwise described, “comprising” or “containing” refers to include a certain constitutional element (or constitutional component) without specific limitation, and it cannot be interpreted to exclude the addition of other constitutional elements (or constitutional components).

According to one embodiment of the invention, there is provided a polymerized toner comprising a specific functional macro monomer, a polymer thereof, or a mixture thereof, in addition to a binder resin, and a pigment, a pigment stabilizer, a charge control agent, and wax.

The inventors confirmed that if a polymerized toner is prepared by suspension polymerization using a specific functional macro monomer, the polymerized toner may be fixed at low temperature in a development process, and thus, it may be energy-efficient and have high glossiness when applied for printing, and completed the invention. Therefore, the polymerized toner of the invention may be applied in the application field such as development of electronic photographs and the like, which requires realization of uniform image, and printed products with excellent qualities of high resolution and color realization degree may be obtained using the same.

First, in the polymerized toner of the invention, a “functional macro monomer” refers to a compound that contains a vinyl group while including oligomer, and thus can participate in a polymerization reaction, and participates in polymerization when monomers for a binder resin are polymerized, thereby performing a structural function for forming a side chain through oligomer in a polymer chain. The functional macro monomer may be represented by the following Chemical Formula 1. The functional macro monomer may be selected from the group consisting of acryl macro monomer or methacryl macro monomer, and a polymer of the macro monomer, namely, a polymer including the macro monomer as repeat unit, and they can be used alone or in combination of two or more kinds.

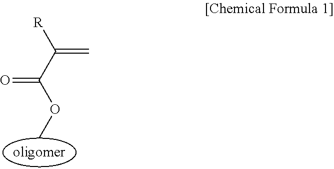

wherein,

R is hydrogen or methyl,

oligomer is independently ester oligomer, urethane oligomer, olefin oligomer, ethyleneglycol oligomer, methyl siloxane oligomer, dimethyl dichlorosilane oligomer, dimethyl polysiloxane oligomer, hexamethyldisilazane oligomer, amino silane oligomer, alkyl silane oligomer, or octamethylcyclotetrasiloxane oligomer.

In the Chemical Formula 1, the oligomer may be ethyleneglycol oligomer, urethane oligomer, methylsiloxane oligomer, dimethyldichlorosilane oligomer, dimethylpolysiloxane oligomer, hexamethyldisilazane oligomer, amino silane oligomer, alkyl silane oligomer, octamethylcyclotetrasiloxane oligomer, and the like according to the structure of the molecule forming the chain. And, each oligomer may be urethane oligomer, olefin oligomer, methyl siloxane oligomer, dimethyldichlorosilane oligomer, dimethylpollysiloxane oligomer, hexamethyldisilazane oligomer, amino silane oligomer, alkyl silane oligomer, or octamethylcyclotetrasiloxane oligomer, and the like, so that the functional macro monomer, a polymer thereof, or a mixture thereof is located on the surface of a polymerized toner prepared by suspension polymerization and improves releasability from a fixing roll in a development process.

As explained above, since the polymerized toner of the invention comprises the functional macro monomer such as acryl macro monomer or methacryl macro monomer and the like, it may be fixed at low temperature in a development process, even if a toner is prepared by suspension polymerization, and simultaneously exhibit high glossiness and excellent transfer efficiency.

The acryl macromonomer may be at least one selected from the group consisting of polyethyleneglycol acrylate, polyester acrylate, polyurethane acrylate, polysiloxane acrylate, silicone polyester acrylate, and silicone polyurethane acrylate. And, the methacryl macromonomer may be at least one selected from the group consisting of polyethyleneglycol methacrylate, polyester methacrylate, polyurethane methacrylate, and polysiloxane methacrylate. At this time, oligomer having low surface tension is advantageously used so that the oligomer may increase releasability of a fixing roll and a toner in a fixing process to prevent offset. And, the functional monomer may be at least one selected from the group consisting of polyurethane acrylate, and polysiloxane acrylate so that it is located on the surface of the finally prepared polymerized toner and improves releasability from a fixing roll in a development process,

And, the functional macro monomer represented by the Chemical Formula 1 may have weight average molecular weight of 500 to 5,000, preferably 600 to 4,000, more preferably 800 to 3,500. The weight average molecular weight of the functional macro monomer may be 500 or more so as to secure uniform image, and it may be 5,000 or less so as to secure excellent glossiness.

The functional macro monomer may be included in the amount of 0.05 to 5 parts by weight, preferably 0.06 to 3.5 parts by weight, 0.07 to 2.5 parts by weight, 0.08 to 1 parts by weight, or 0.1 to 0.95 parts by weight, based on total weight of the polymerized toner. The functional macro monomer may be included in the amount of 0.05 parts by weight or more so as to decrease fixing temperature and secure excellent glossiness, and it may be included in the amount of 5 parts by weight so as to improve image uniformity of the toner.

The functional macro monomer is copolymerized with monomer for a binder resin by the preparation process described below, and the oligomer of the macro monomer may appear on the side chain of the main chain of the binder resin. For example, the oligomer chain of the macro monomer may be randomly bonded as a side chain to a styrene/acryl copolymer main chain of a binder resin.

Meanwhile, the monomer for a binder resin may include all monomers used in a toner prepared by polymerization without specific limitations. Specific examples of the monomer may include styrene monomer, acrylate monomer, methacrylate monomer, or diene monomer, and the like, and they may be used alone or in combination of two or more kinds. And, at least one of acidic olefin monomer or basic olefin monomer may be optionally mixed with the monomer.

The binder resin may include a polymer or a copolymer of styrene monomers, acrylate monomers, methacrylate monomers, diene monomers, acidic olefin monomers and basic olefin monomers, or a mixture thereof. However, various monomers known to be usable to form a toner prepared by suspension polymerization may be used without specific limitation, and a polymer or a copolymer that becomes a binder resin of a polymerized toner may be formed from the monomers.

And, the binder resin may include a polymer or a copolymer of (a) styrene monomer; and (b) at least one selected from the group consisting of acrylate monomer, methacrylate monomer and diene monomer. The polymer may include 30 to 95 parts by weight of the (a) monomers, and 5 to 70 parts by weight of the (b) monomers, based on 100 parts by weight of the sum of the (a) monomers and the (b) monomers.

The polymer may be a polymer of (a) styrene monomer, (b) at least one selected from the group consisting of acrylate monomer, methacrylate monomer and diene monomer, and (c) at least one selected from the group consisting of acidic olefin monomer and basic olefin monomer. The (c) monomers may be polymerized in the amount of 0.1 to 30 parts by weight, based on 100 parts by weight of the sum of the (a) monomers and the (b) monomers.

The styrene monomer for a binder resin may include styrene, monochlorostyrene, methylstyrene, dimethylstyrene, and the like, and the acrylate monomer may include methylacrylate, ethylacrylate, n-butylacrylate, isobutylacrylate, dodecyl acrylate, 2-ethylhexylacrylate, and the like. And, the methacrylate monomer may include methyl methacrylate, ethyl methacrylate, n-butyl methacrylate, isobutyl methacrylate, dodecyl methacrylate, 2-ethylhexyl methacrylate, and the like, and the diene monomer may include butadiene, isoprene, and the like.

And, as the acidic olefin monomer, an α,β-ethylene unsaturated compound having a carboxylic acid group, and the like may be used, and as the basic olefin monomer, methacrylate ester of aliphatic alcohol having an amine group or a quaternary ammonium group, methacryl amide, vinyl amine, diallyl amine or an ammonium salt thereof, and the like may be used.

Meanwhile, according to one embodiment of the invention, the toner particles may comprise a binder resin, and a pigment, a pigment stabilizer, a charge control agent, and wax, which are dispersed in the binder resin. And, the toner particles may comprise 50 to 95 wt %, preferably 60 to 93 wt %, more preferably 70 to 90 wt % of a binder resin; 1 to 20 wt %, preferably 2 to 15 wt %, more preferably 3 to 10 wt % of a pigment; 0.1 to 20 wt %, preferably 0.2 to 15 wt %, more preferably 0.3 to 10 wt % of a pigment stabilizer; 0.1 to 5 wt %, preferably 0.3 to 4 wt %, more preferably 0.5 to 3 wt % of a charge control agent; 0.1 to 30 wt %, preferably 1 to 25 wt %, more preferably 5 to 20 wt % of wax; and 0.05 to 5 wt %, preferably 0.08 to 4 wt %, more preferably 0.1 to 3.5 wt % of a functional macro monomer. By maintaining the contents of the binder resin, and the pigment, pigment stabilizer, charge control agent, and wax, dispersed in the binder resin within the above range, the polymerized toner may exhibit uniform image with excellent image density and excellent transfer efficiency, and simultaneously, effectively prevent offset phenomenon whereby a toner pollutes a fixing roll.

The pigment may include metal powder pigment, metal oxide pigment, carbon pigment, sulfide pigment, chromium salt pigment, ferrocyanide pigment, azo pigment, acid salt pigment, basic dye pigment, mordant dye pigment, phthalocyanine, quinacridone pigment, and dioxane pigment, and a mixture thereof. However, it is not limited thereto, and pigments known to be applicable in a polymerized toner may be used without specific limitation.

The charge control agent may include a cationic charge control agent, an anionic charge control agent, and a mixture thereof. The cationic charge control agent may include nigrosine-type dye, a metal salt of higher aliphatic compound, alkoxy amine, chelate, a quaternary ammonium salt, alkylamide, a fluorinated activator and a metal salt of naphthalenic acid, and a mixture thereof; and the anionic charge control agent may include chlorinated paraffin, chlorinated polyester, acid-containing polyester, sulfonyl amine of copper phthalocyanine, a sulfonic acid group, and a mixture thereof.

And, a copolymer having a sulfonic acid group is preferably used as the charge control agent, and more preferably, a copolymer having a sulfonic acid group and having weight average molecular weight of 2,000 to 200,000 may be used, and still more preferably, a copolymer having a sulfonic acid group having an acid value of 1 to 40 mg KOH/g and glass transition temperature of 30 to 120° C. may be used. If the acid value is less than 1, it cannot perform a function as a charge control agent, and if the acid value is 40 or more, it may influence on the interfacial property of the monomer mixture to worsen polymerization stability. And, if the glass transition temperature is less than 30° C., friction-melting of toner may be generated when printing due to low glass transition temperature of the charge control agent that is exposed on the surface, thus inducing blocking, and if it is greater than 120° C., the surface of toner may become excessively hard and it is not preferable in terms of coatability and fixability. And, if the weight average molecular weight is less than 2,000, surface concentration may be lowered due to high compatibility with a binder resin and the function of a charge control agent may not be manifested, and if it is greater than 200,000, the viscosity of the monomer mixture may be increased due to high molecular weight, and it is not preferable in terms of polymerization stability and particle size distribution. Specific examples of the copolymer having a sulfonic acid group may include a styrene-acrylic copolymer having a sulfonic acid group, a styrene-methacrylic copolymer having a sulfonic acid group, and a mixture thereof, but not limited thereto.

As the pigment stabilizer, styrene-butadiene (SBS) copolymer having weight average molecular weight of 2,000 to 200,000 may be used, and preferably, the copolymer having a weight ratio of styrene and butadiene of 10:90 and 90:10 may be used. If the content of styrene is greater than 90%, the length of a butadiene block may be decreased, and thus, stabilizer function may not be sufficiently manifested due to high compatibility with a binder resin, and if it is less than 10%, although stabilizer function may be sufficiently manifested, pigment to pigment function may not be sufficiently controlled due to the short length of a styrene block. And, if the molecular weight is less than 2,000, it may not function as a pigment due to high compatibility with a binder resin, and if the molecular weight is greater than 200,000, the viscosity of a monomer mixture may be too increased to worsen dispersion stability and polymerization stability, and ultimately, widen particle size distribution.

As the wax, any wax known to be applicable in a polymerized toner may be used without specific limitation. For example, petroleum wax such as paraffin wax, microcrystalline wax, or ceresin wax, and the like; natural wax such as carnauba wax, and the like; or synthetic wax such as polyester wax or polyolefin wax, and the like, or combinations thereof may be used.

Meanwhile, according to one embodiment of the invention, the toner particles may further comprise at least one additives selected from the group consisting of a reaction initiator, a cross linking agent, a molecular weight control agent, a lubricant (for example, oleic acid, stearic acid, and the like) and a coupling agent. The toner particles may further comprise 10 wt % or less, or 0.1 to 10 wt %, preferably 8 wt % or less, or 0.3 to 8 wt %, more preferably 5 wt % or less, or 0.5 to 5 wt % of the reaction initiator; 5 wt % or less, or 0.01 to 5 wt %, preferably 4 wt % or less, or 0.05 to 4 wt %, more preferably 3 wt % or less, or 0.1 to 3 wt % of the cross linking agent; 10 wt % or less, or 0.1 to 10 wt %, preferably 8 wt % or less, or 0.3 to 8 wt %, more preferably 5 wt % or less, or 0.5 to 5 wt % of the molecular weight control agent; appropriate amount of the lubricant (for example, oleic acid, stearic acid, and the like), for example, 5 wt % or less, or 0.01 to 5 wt %, preferably 4 wt % or less, or 0.05 to 4 wt %, more preferably 3 wt % or less, or 0.1 to 3 wt % of the lubricant; appropriate amount of the coupling agent, for example, 5 wt % or less, or 0.01 to 5 wt %, preferably 4 wt % or less, or 0.05 to 4 wt %, more preferably 3 wt % or less, or 0.1 to 3 wt % of the coupling agent, or combinations thereof.

As the reaction initiator, oil-soluble initiators and water-soluble initiators may be used. Specifically, azo initiators such as azobisisobutyronitrile, azobisvaleronitrile, and the like; organic peroxide such as benzoylperoxide, lauroylperoxide, and the like; commonly used water-soluble initiators such as potassium persulfate, ammonium persulfate, and the like may be used, and they may be used alone or in combinations of two or more kinds.

The cross linking agent may include divinylbenzen, ethylene dimethacrylate, ethyleneglycol dimethacrylate, diethyleneglycol diacrylate, 1,6-hexamethylene diacrylate, allyl methacrylate, 1,1,1-trimethylolpropane triacrylate, triallylamine, tetra allyloxy ethane, and a mixture thereof.

The molecular weight control agent may include t-dodecyl mercaptan, n-dodecyl mercaptan, n-octylmercaptan, carbon tetrachloride, and a mixture thereof.

As the lubricant and the coupling agent, those known to be applicable in the preparation of a polymerized toner may be used without specific limitation.

The polymerized toner of the present invention may comprise 50 to 95 wt % of a binder resin; 1 to 20 wt % of a pigment; 0.1 to 20 wt % of a pigment stabilizer; 0.1 to 5 wt % of a charge control agent; 0.1 to 30 wt % of wax; 0.05 to 5 wt % of a functional macro monomer; and 10 wt % or less, or 0.01 to 10 wt % of at least one additives selected from the group consisting of a reaction initiator, a cross linking agent, a molecular weight control agent, a lubricant, and a coupling agent.

And, according to one embodiment, the toner particles may further comprise a coating layer containing external additives such as silica, titanium dioxide or a mixture thereof, and the like. The external additives may be coated on the outermost part of the toner particles. The silica may be preferably surface-treated with a silane compound such as dimethyldichlorosilane, dimethylpolysiloxane, hexamethyldisilazane, aminosilane, alkylsilane or octamethylcyclotetrasiloxane, and the like. As the titanium dioxide, rutile-type titanium dioxide that is stable at high temperature or anatase-type titanium dioxide that is stable at low temperature may be used alone or in combination, and those having particle size of 80 to 200 nm, preferably 100 to 150 nm may be applied.

In the polymerized toner of the present invention, the toner particles may have average particle diameter of 4 to 10 μm, preferably 5 to 8 μm, more preferably 6 to 7 μm. The average particle diameter of the toner particles may be 4 μm or more in terms of image density and prevention of scattering, and it may be 10 μm or less so as to reduce consumption amount.

Meanwhile, according to another embodiment of the invention, a method for preparing the polymerized toner is provided. Particularly, the method for preparing a polymerized toner may comprise forming an aqueous dispersion comprising a dispersant; forming a monomer mixture comprising monomers for a binder resin, a pigment, a pigment stabilizer, a charge control agent, wax, and a functional macro monomer represented by the following Chemical Formula 1, a polymer thereof or a mixture thereof; and adding the monomer mixture to the aqueous dispersion to form toner particles through suspension polymerization. Wherein, the functional macro monomer may have weight average molecular weight of 500 to 5,000, preferably 600 to 4,000, more preferably 800 to 3,500, and the functional macro monomer may be included in the content of 0.05 to 5 parts by weight, preferably 0.06 to 3.5 parts by weight, 0.07 to 2.5 parts by weight, 0.08 to 1 parts by weight, or 0.1 to 0.95 parts by weight, based on total weight of the monomers for a binder resin.

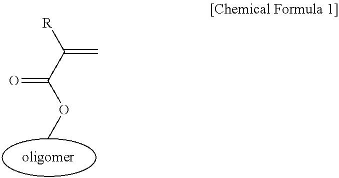

wherein

R is hydrogen or methyl,

oligomer is independently ester oligomer, urethane oligomer, olefin oligomer, ethyleneglycol oligomer, methylsiloxane oligomer, dimethyldichlorosilane oligomer, dimethylpolysiloxane oligomer, hexamethyldisilazane oligomer, aminosilane oligomer, alkylsilane oligomer, or octamethylcyclotetrasiloxane oligomer.

Specific examples of the functional macro monomer and acryl macro monomer, methacryl macro monomer, oligomer, and the like are as explained above.

The inventors confirmed that if a specific functional macro compound is used when preparing a toner by suspension polymerization, the polymerized toner may be fixed at low temperature in a development process, and thus, is energy-efficient, and may have high glossiness when applied for printing, and completed the present invention. If the polymerized toner is applied, glossiness of the printed product may be increased, and thus, it may be effectively applied in the field of photograph printing and the like, which requires high resolution and color realization degree.

Particularly, when a toner is prepared using the above functional macro monomer, if an emulsion method wherein a binder resin, macromonomer, wax, a pigment, a charge control agent, and the like are aggregated to prepare toner particles is applied instead of the above explained suspension polymerization, it may be difficult to increase the concentration of the macromonomers on the surface of the toner particles. In the toner prepared by the emulsion method, macro monomers are almost uniformly distributed in the particles, while in the polymerized toner prepared by suspension polymerization according to the present invention, macro monomers are more distributed to the surface of the particles and the surface concentration thereof becomes higher than the bulk concentration, and thus, it may be fixed at low temperature in a development process even in a small amount, and it may effectively realize excellent performance such as high glossiness and the like when printing.

According to another embodiment of the invention, a dispersant may be mixed with water to form the aqueous dispersion. In order to homogenize the aqueous dispersion, a step of agitating or applying shearing stress may be applied. Specifically, the step of forming an aqueous dispersion may comprise mixing a sodium phosphate aqueous solution and a calcium chloride aqueous solution to obtain crystalline potassium phosphate in the aqueous solution phase. The potassium phosphate may be used as a dispersant, and the aqueous dispersion may include potassium phosphate crystals uniformly dispersed in water.

The dispersant may prevent aggregation of monomers for a binder resin or pigments and the like that exist as droplets between particles, and allows uniform dispersion of the particles. And, the dispersant may be uniformly adsorbed to the surface of droplets to stabilize the droplets. And, the dispersant may be solubilized in the aqueous medium by acid or alkali treatment, or hot water washing and the like, after a polymerization reaction is completed, and it may be separated from toner particles.

The dispersant includes an inorganic dispersant, an organic dispersant, an anionic surfactant or a mixture thereof. The dispersant may be applied in the amount of 1 to 5 parts by weight, preferably 2 to 4 parts by weight, more preferably 2.5 to 3.5 parts by weight, based on 100 parts by weight of the monomer mixture.

Specific examples of the inorganic dispersant may include calcium phosphate, calcium hydrogen phosphate, monocalcium phosphate, hydroxy apatite, magnesium phosphate, aluminum phosphate, zinc phosphate, calcium carbonate, magnesium carbonate, calcium hydroxide, magnesium hydroxide, aluminum hydroxide, calcium metasilicate, calcium sulfate, barium sulfate, bentonite, silica, alumina, or a mixture thereof, and the like.

Specific examples of the water-soluble organic dispersant may include polyvinyl alcohol, gelatin, methyl cellulose, methyl hydroxy propyl cellulose, ethyl cellulose, carboxyl methyl cellulose and a sodium salt thereof, polyacrylic acid and a salt thereof, starch, or a mixture thereof, and the like.

Specific examples of the anionic surfactant may include fatty acid salts, alkyl ester sulfate, alkylaryl ester sulfate, dialkyl sulfosuccinate, alkyl diphosphate, and a mixture thereof, and the like.

More preferable example of the dispersant may include calcium phosphate. The calcium phosphate may be obtained in the form of crystals in an aqueous solution phase by mixing a sodium phosphate aqueous solution and a calcium chloride aqueous solution, and the aqueous dispersion may include calcium phosphate crystals uniformly dispersed in water.

Meanwhile, the monomer mixture may be formed by mixing the monomers for a binder resin, pigment, pigment stabilizer, charge control agent and wax, and the like, and sufficiently dissolving them, and it may be homogenized in the aqueous dispersion using a homogenizer.

The monomer for a binder resin may include styrene monomer, acrylate monomer, methacrylate monomer, diene monomer, acidic olefin monomer, basic olefin monomer, and a mixture thereof.

And, the monomer for a binder resin may comprise (a) styrene monomer; and (b) at least one selected from the group consisting of acrylate monomer, methacrylate monomer and diene monomer. The monomer for a binder resin may comprise 30 to 95 parts by weight of the (a) monomers and 5 to 70 parts by weight of the (b) monomers, based on 100 parts by weight of the sum of the (a) monomers and the (b) monomers.

And, the monomer for a binder resin may comprise (a) styrene monomer, (b) at least one selected from the group consisting of acrylate monomer, methacrylate monomer and diene monomer, and (c) at least one selected from the group consisting of acidic olefin monomer and basic olefin monomer. The (c) monomers may be included in the amount of 0.1 to 30 parts by weight, based on 100 parts by weight of the sum of the (a) monomers and the (b) monomers.

Meanwhile, specific examples of the monomer for a binder resin, pigment, pigment stabilizer, charge control agent, and wax are as explained above. And, the monomer mixture may comprise 50 to 95 wt % (percent by weight) of the monomers for a binder resin, 1 to 20 wt % of the pigment, 0.1 to 20 wt % of the pigment stabilizer, 0.1 to 5 wt % of the charge control agent, 0.1 to 30 wt % of the wax, and 0.05 to 5 wt % of the functional macro monomer.

Toner particles may be formed by mixing the monomer mixture in the aqueous dispersion and conducting suspension polymerization. More specifically, the step of forming the toner particles may comprise adding the monomer mixture to the aqueous dispersion; applying shearing stress to the aqueous dispersion and the monomer mixture to homogenize the monomer mixture in the aqueous dispersion in the form of droplets; and suspension-polymerizing the homogenized monomer mixture. And, as explained above, the monomer mixture and the aqueous dispersion may be homogenized using a homogenizer.

By dispersing the monomer mixture in the aqueous solution in the form of fine droplets and conducting polymerization, spherical toner particles with appropriate size may be formed. For the dispersion in the form of fine droplets, shearing stress may be applied to the monomer mixture and the aqueous dispersion to homogenize using a homogenizer, and specifically, the monomer mixture that is mixed with the aqueous dispersion may be homogenized at 5,000 rpm to 20,000 rpm, preferably 8,000 rpm to 17,000 rpm using a homogenizer, so as to disperse the monomer mixture in the aqueous dispersion in the form of droplets.

The suspension polymerization may be conducted at 60 to 90° C. for 8 to 20 hours. More preferably, after progressing the suspension polymerization reaction at 50 to 70° C. for 8 to 12 hours, temperature may be increased to 80 to 110° C., and then, the reaction may be progressed for 30 minutes to 4 hours, According to the suspension polymerization, a polymerized toner wherein the ratio of toner particles including 2 or more wax domains is 10% to 60% of total toner particles may be prepared, thus exhibiting high glossiness and transfer efficiency.

Meanwhile, according to another embodiment of the invention, the method for preparing a polymerized toner may further comprise removing the dispersant; and drying the toner particles.

The step of removing the dispersant may comprise controlling pH so as to be appropriate for dissolving the dispersant. By adding water-soluble inorganic acid such as hydrochloric acid or nitric acid, and the like, to the dispersion including produced toner particles so as to control the pH to 2 or less, preferably 1.5 or less, the dispersant may be dissolved in an aqueous solution phase and removed from the toner particles. In the step of removing the dispersant, pH is appropriately controlled, the solution is agitated for 5 hours or more so as to sufficiently dissolve the dispersant, and then, toner slurry containing less than 50 wt % of water may be obtained using a filter. And, in the step of removing the dispersant, application of shearing stress to homogenize the solution using a homogenizer, and separation with a centrifuge may be applied. And, after the above explained step of removing the dispersant, removing moisture using a filter and adding an excessive amount of distilled water may be repeated several times to more efficiently remove the dispersant.

The step of drying toner particles may comprise putting dispersant-removed toner cake in a vacuum oven and vacuum-drying at room temperature. However, any drying methods known to be commonly used in the preparation of a polymerized toner may be used without specific limitations.

And, according to one embodiment of the invention, the method for preparing a polymerized toner may further comprise coating the outside of the toner particles. In the coating step, separate external additives, for example, inorganic powder containing silica, titanium dioxide or a mixture thereof, and the like may be coated on the surface of toner particles, and the coating of external additives may be progressed by adding the external additives to the toner particles and then agitating at high speed using an henschel mixer. As the silica, those known to be usable in a polymerized toner may be used without specific limitation. Inoragnic powder that can be applied in the coating step is as explained above, and the detailed explanations thereof are omitted.

And, the method may further comprise adding at least one additives selected from the group consisting of a reaction initiator, a cross linking agent, a lubricant, a molecular weight control agent, and a coupling agent to the monomer mixture. Specific examples and preferable contents of the additives are as explained above.

Meanwhile, the polymerized toner according to the present invention may be fixed at low temperature of 125° C. or less, or 100 to 125° C., preferably 120° C. or less, more preferably 110° C. or less in a development process, and thus, improve energy efficiency, and simultaneously secure excellent glossiness. In the development process of a polymerized toner, lower fixing temperature is advantageous in terms of energy efficiency. The fixing temperature of toner may be lowered by controlling glass transition temperature (Tg) of a binder resin. However, if glass transition temperature (Tg) of a binder resin is too low, particles may be aggregated during storage of toner, and thus, there is a limitation in improving the fixing temperature by lowering the glass transition temperature (Tg) of a binder resin.

And, the polymerized toner of the present invention may have narrow particle diameter distribution, and allow uniform image realization with high image density and excellent transfer efficiency. Particularly, it may have transfer efficiency of 90% or more, and gloss unit of 30 or more in a printed paper.

Other details may be adjusted as necessary, and are not specifically limited in the present invention.

### Advantageous Effects

According to the present invention, since a polymerized toner comprising a specific functional macro compound is prepared by suspension polymerization, it may be fixed at low temperature in a development process, and thus, a polymerized toner having remarkably improved energy efficiency and a method for preparing the same are provided.

Particularly, the polymerized toner of the present invention may exhibit high glossiness and excellent transfer efficiency, and thus, may exhibit very excellent performance in the application field such as development of electronic photographs, and the like.

### MODE FOR INVENTION

Hereinafter, preferable examples are presented to aid in understanding of the present invention, however, these examples are only to illustrate the invention and the scope of the invention is not limited thereto.

### Example 1

### Preparation of Polymerized Toner

686 g of a 0.1 M sodium phosphate aqueous solution and 100 g of 1M calcium chloride were mixed in 500 g of water, and agitated at a reaction temperature of 70° C. for 20 minutes to prepare an aqueous dispersion including precipitated calcium phosphate crystals. In the aqueous dispersion, the content of calcium phosphate crystals was adjusted to 3 parts by weight, based on 100 parts by weight of a monomer mixture described below.

160 g of styrene, 36 g of n-butyl acrylate, and 4 g of acrylic acid as monomers for a binder resin, 4 g of allylmethacrylate as a cross linking agent, 0.4 g of n-dodecyl mercaptan as a molecular weight control agent, 3 g of styrene-butadiene-styrene (SBS) block copolymer having weight average molecular weight of 10,000 as a pigment stabilizer, 4 g of a styrene-acrylic polymer charge control agent containing a sulfonic acid group and having weight average molecular weight of 16,500 (Styrene/2EHA/anionic functional monomer copolymer, FCA 1001 NS, Fujikura Kasei), and 2.06 g of polyethylene glycol acrylate (Mw: 1,026) as a functional macro monomer (0.95 wt % based on total weight of polymerized toner, 1.0 parts by weight, based on 100 parts by weight of total weight of the monomers for a binder resin) were mixed and sufficiently dissolved, 10 g of carbon black was added, and the mixture was agitated in a bead mill at 2,000 rpm for 1 hour, and then, the bead was removed.

To the bead-removed mixture, 20 g of paraffin wax (Fisher) was added and the mixture was agitated to completely dissolve the wax in the mixture, and 5 g of an azo nitrile initiator (V65, Waco Chemical) was added and the mixture was agitated for additional 5 minutes to prepare a monomer mixture. The weight of the monomer mixture was 246.4 g.

And, the monomer mixture was added to the aqueous dispersion, and shearing stress was applied at 13,000 rpm using a homogenizer to disperse and homogenize the monomer mixture in the aqueous dispersion in the form of fine droplets. The monomer mixture dispersed in the aqueous dispersion in the form of fine droplets through homogenization was reacted at 60° C. for 10 hours while agitating at 200 rpm with a paddle-type agitator, the temperature was increased to 90° C., and the mixture was reacted for additional 3 hours to prepare a polymerized toner.

Washing and Drying of Toner Particles

Hydrochloric acid was added to the slurry including a polymerized toner to control the pH to 2 or less, and calcium phosphate was dissolved therein. And, water was removed using a filter, distilled water was added in the amount of 2 times of total weight to dilute the slurry, shearing stress was applied to homogenize it using a homogenizer, and then, centrifugation was conducted at 3,000 rpm for 15 minutes using a centrifugal device (Beckman J2-21M, Rotor JA-14). The process of dilution, homogenization and centrifugation was repeated three times to remove calcium phosphate and other impurities on the surface of toner.

Finally, moisture was removed through filtering, and then, the toner cake was put in a vacuum oven and vacuum-dried at room temperature for 48 hours to prepare a polymerized toner core. The volume average particle diameter of the prepared polymerized toner core was 7 μm, and the ratio of volume average particle diameter and number average particle diameter (standard deviation) was 1.26. The volume average particle diameter of the core was measured using a Coulter counter (Multisizer 3, Beckman coulter).

Coating of External Additives

2 parts by weight of silica was mixed with 100 parts by weight of the polymerized toner core using a henshcel mixer. Then, it was agitated at high speed of 5,000 rpm for 7 minutes to coat external additives on the surface of the polymerized toner core.

### Examples 2 to 9

A polymerized toner was prepared by the same method as Example 1, except that the component and the content of the functional macro monomer were changed, as shown in the following Table 1.

### Comparative Example 1

A polymerized toner was prepared by the same method as Example 1, except that the functional macro monomer was not used, as shown in the following Table 1.

### Comparative Examples 2 to 5

A polymerized toner was prepared by the same method as Example 1, except that the component and the content of the functional macro monomer were changed, as shown in the following Table 1.

### Experimental Example

For the polymerized toners prepared according to Examples 1 to 9 and Comparative Examples 1 to 5, physical properties were evaluated as follows.

Image Uniformity

After printing on the front side of A4 paper with a laser printer (HP2600, Manufacturer: Hewlett-Packard), the printed side was uniformly divided into 20 parts, and image density of each part was measured with an image densitometer (RD918, Macbath). If the difference between measured image densities is less than 0.1, it was judged that image is uniform, and if the difference is 0.1 or more, it was judged that the image is non-uniform.

Measurement of Fixing Temperature

Fixing temperature was measured by artificially applying Jam in a laser printer (CP2025, manufacturer: Hewlet Packard) to obtain unfixed image, and then, using the image, measuring OFF-SET temperature under pressure of 1 kgf/cm² and speed of 23 PPM using a Teflon-coated silicon roller (QIR220-1200 Roller, Manufacturer: LG. Chemical) according to temperature while increasing temperature from low temperature.

Measurement of Glossiness

After printing on the front side of A4 paper with a laser printer (CP1215, Manufacturer: Hewlet Packard), gloss units of 4 edge parts and 1 center part of the printed paper were measured using a gloss meter (RD918, McBath) and the average value was taken.

The measurement results of the fixing temperatures and the gloss units of the polymerized toners prepared according to Examples 1 to 9 and Comparative Examples 1 to 5 are as shown in the following Table 1.

TABLE 1

| | | | Content | | | |
|---|---|---|---|---|---|---|
| | | Molecular | of macro- | | | |
| | | weight of | monomer | | | |
| | | macro- | in toner | | Fixing | |
| | Kind of | monomer | particles | Image | temperature | Gloss |
| | macromonomer | (Mw) | (wt %) | uniformity | (° C.) | unit |
| Example 1 | Polyethylene- | 1,026 | 0.95 | Uniform | 110 | 40 |
| | glycol | | | | | |
| | acrylate | | | | | |
| Example 2 | Polyethylene- | 1,026 | 0.1 | Uniform | 115 | 35 |
| | glycol | | | | | |
| | acrylate | | | | | |
| Example 3 | Polyethylene- | 3,000 | 0.95 | Uniform | 110 | 38 |
| | glycol | | | | | |
| | acrylate | | | | | |
| Example 4 | Polyethylene- | 1,040 | 0.95 | Uniform | 110 | 40 |
| | glycol | | | | | |
| | methacrylate | | | | | |
| Example 5 | polyester | 1,000 | 0.95 | Uniform | 110 | 40 |
| | acrylate | | | | | |
| Example 6 | polyurethane | 1,000 | 0.95 | Uniform | 110 | 40 |
| | acrylate | | | | | |
| Example 7 | polysiloxane | 1,000 | 0.95 | Uniform | 110 | 40 |
| | acrylate | | | | | |
| Comparative | — | — | — | Uniform | 130 | 25 |
| Example 1 | | | | | | |
| Comparative | Polyethylene- | 1,026 | 0.03 | Uniform | 130 | 25 |
| Example 2 | glycol | | | | | |
| | acrylate | | | | | |
| Comparative | Polyethylene- | 1,026 | 7 | Non- | — | — |
| Example 3 | glycol | | | uniform | | |
| | acrylate | | | | | |
| Comparative | polyethyleneglycol | 300 | 0.95 | Non- | — | — |
| Example 4 | acrylate | | | uniform | | |
| Comparative | Polyethylene- | 6,000 | 0.95 | Uniform | 110 | 25 |
| Example 5 | glycol | | | | | |
| | acrylate | | | | | |

As shown in the Table 1, it was confirmed that the polymerized toners of Examples 1 to 9 comprising a specific functional macro monomer may exhibit high glossiness at low fixing temperature. Specifically, if the polymerized toners of Examples 1 to 9 are applied, a development process may be conducted at low fixing temperature of 110 to 115° C. The prepared polymerized toner of Examples 1 to 9 may have remarkably improved gloss unit of 35 to 40.

To the contrary, it was confirmed that in the case of Comparative Examples 1 to 5 wherein the functional macro monomer is not used or the content does not fall within optimum range, low temperature fixing performance, image uniformity, glossiness, and the like are not good. Particularly, in the case of Comparative Examples 1 which does not include the functional macro monomer, fixing temperature was high as 130° C., and thus, cold off set problem may be generated, and simultaneously, gloss unit was remarkably lowered as about 25. In the case of Comparative Example 2 which includes the function macro monomer in a small amount of 0.03%, it was difficult to secure the low temperature fixing property and excellent glossiness. To the contrary, in the case of Comparative Example 3 which includes the functional macro monomer in an excessive amount of 7%, image uniformity was remarkably lowered, and thus, fixing temperature and glossiness could not be measured. Meanwhile, in the case of Comparative Example 4 wherein the functional macro monomer has weight average molecular weight of 300, image was not uniform and thus, fixing temperature and gloss could not be measured. Also, in the case of Comparative Example 5 wherein the functional macro monomer has weight average molecular weight of 6,000, fixing temperature was lowered, but gloss unit was low as 25.

1. A polymerized toner comprising
a binder resin; and
a pigment, a pigment stabilizer, a charge control agent, wax, and a functional macro monomer represented by the following Chemical Formula 1, a polymer thereof, or a mixture thereof, which are dispersed in the binder resin,
wherein the functional macro monomer has weight average molecular weight of 500 to 5,000, and is included in the amount of 0.05 to 5 parts by weight, based on total weight of the toner: 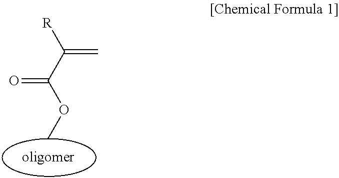
wherein,
R is hydrogen or methyl,
oligomer is independently ester oligomer, urethane oligomer, olefin oligomer, ethyleneglycol oligomer, methylsiloxane oligomer, dimethyldichlorosilane oligomer, dimethylpolysiloxane oligomer, hexamethyldisilazane oligomer, aminosilane oligomer, alkylsilane oligomer, or octamethylcyclotetrasiloxane oligomer.

2. The polymerized toner according to claim 1, wherein oligomer of the Chemical Formula 1 is independently urethane oligomer, olefin oligomer, methylsiloxane oligomer, dimethyldichlorosilane oligomer, dimethylpolysiloxane oligomer, hexamethyldisilazane oligomer, aminosilane oligomer, alkylsilane oligomer, or octamethylcyclotetrasiloxane oligomer.

3. The polymerized toner according to claim 1, wherein the functional macro monomer is at least one selected from the group consisting of polyethyleneglycol acrylate, polyester acrylate, polyethyleneglycol methacrylate, polyurethane acrylate, and polysiloxane acrylate.

4. The polymerized toner according to claim 1, wherein the functional macro monomer is at least one selected from the group consisting of polyurethane acrylate and polysiloxane acrylate.

5. The polymerized toner according to claim 1, wherein the functional macro monomer has weight average molecular weight of 600 to 4,000.

6. The polymerized toner according to claim 1, wherein the functional macro monomer is included in the amount of 0.06 to 3.5 parts by weight, based on total weight of the toner.

7. The polymerized toner according to claim 1, wherein the binder resin includes a polymer of at least one selected from the group consisting of styrene monomer, acrylate monomer, methacrylate monomer, diene monomer, acidic olefin monomer, and basic olefin monomer.

8. The polymerized toner according to claim 1, wherein the binder resin includes a polymer of (a) styrene monomer; and (b) at least one selected from the group consisting of acrylate monomer, methacrylate monomer, and diene monomer.

9. The polymerized toner according to claim 1, wherein the polymer includes a polymer of the (a) styrene monomer, (b) at least one selected from the group consisting of acrylate monomers, methacrylate monomer, and diene monomers, and (c) at least one selected from the group consisting of acidic olefin monomer and basic olefin monomer.

10. The polymerized toner according to claim 1, wherein the wax includes at least one selected from the group consisting of paraffin wax, microcrystalline wax, ceresin wax, carnauba wax, polyester wax, and polyolefin wax.

11. The polymerized toner according to claim 1, wherein the charge control agent includes at least one cationic charge control agent selected from the group consisting of nigrosine-type dye, a metal salt of higher aliphatic compound, alkoxy amine, chelate, a quaternary ammonium salt, alkylamide, a fluorinated activator and a metal salt of naphthalenic acid; or at least one anionic charge control agent selected from the group consisting of chlorinated paraffin, chlorinated polyester, acid-containing polyester, sulfonyl amine of copper phthalocyanine, and styrene-acrylic-based polymer containing a sulfonic acid group.

12. The polymerized toner according to claim 1, wherein the pigment includes at least one selected from the group consisting of metal powder type pigment, metal oxide type pigment, carbon type pigment, sulfide type pigment, chromium type pigment, ferrocyanide type pigment, azo type pigment, acid salt type pigment, basic dye type pigment, mordant dye type pigment, phthalocyanine, quinacridone type pigment, and dioxane type pigment.

13. The polymerized toner according to claim 1, wherein the pigment stabilizer includes styrene-butadiene-styrene block copolymer having weight average molecular weight of 2,000 to 200,000.

14. The polymerized toner according to claim 1, wherein the polymerized toner comprises 50 to 95 wt % of a binder resin, 1 to 20 wt % of a pigment, 0.1 to 20 wt % of a pigment stabilizer, 0.1 to 5 wt % of a charge control agent, 0.1 to 30 wt % of wax, and 0.05 to 5 wt % of functional macro monomer.

15. The polymerized toner according to claim 1, wherein the toner particles further comprises at least one additive selected from the group consisting of a reaction initiator, a cross linking agent, a molecular weight control agent, a lubricant and a coupling agent.

16. The polymerized toner according to claim 1, wherein the polymerized toner comprises 50 to 95 wt % of a binder resin; 1 to 20 wt % of a pigment; 0.1 to 20 wt % of a pigment stabilizer; 0.1 to 5 wt % of a charge control agent; 0.1 to 30 wt % of wax; 0.05 to 5 wt % of functional macro monomer; and 10 wt % or less of at least one additives selected from the group consisting of a reaction initiator, a cross linking agent, a molecular weight control agent, a lubricant, and a coupling agent.

17. A method for preparing a polymerized toner comprising
forming an aqueous dispersion comprising a dispersant;
forming a monomer mixture comprising monomers for a binder resin, a pigment, a pigment stabilizer, a charge control agent, wax, and a functional macro monomer represented by the following Chemical Formula 1, a polymer thereof, or a mixture thereof; and
adding the monomer mixture to the aqueous dispersion to form toner particles through suspension polymerization,
wherein the functional macro monomer has weight average molecular weight of 500 to 5,000, and is included in the amount of 0.05 to 5 parts by weight, based on total weight of the toner: 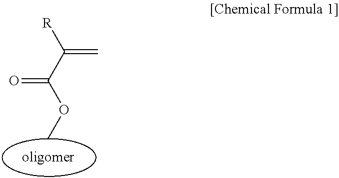
wherein,
R is hydrogen or methyl,
oligomer is independently ester oligomer, urethane oligomer, olefin oligomer, ethyleneglycol oligomer, methylsiloxane oligomer, dimethyldichlorosilane oligomer, dimethylpolysiloxane oligomer, hexamethyldisilazane oligomer, aminosilane oligomer, alkylsilane oligomer, or octamethylcyclotetrasiloxane oligomer.

18. The method for preparing a polymerized toner according to claim 17, wherein the suspension polymerization comprises reacting at 50 to 70° C. for 8 to 12 hours, increasing the temperature to 80 to 100° C., and then, reacting for 30 minutes for 4 hours.

19. The method for preparing a polymerized toner according to claim 17, wherein the dispersant includes at least one selected from the group consisting of an inorganic dispersant, a water-soluble organic polymer dispersant, and an anionic surfactant.

20. The method for preparing a polymerized toner according to claim 17, wherein the monomer mixture further comprises at least one additive selected from the group consisting of a reaction initiator, a crosslinking agent, a molecular weight control agent, a lubricant, and a coupling agent.

21. The method for preparing a polymerized toner according to claim 17, wherein the step of forming toner particles comprises adding the monomer mixture to the aqueous dispersion; applying shearing stress to the aqueous dispersion and the monomer mixture to homogenize the monomer mixture in the aqueous dispersion in the form of droplets; and suspension-polymerizing the homogenized monomer mixture.
